(19) United States
(12) Patent Application Publication
(10) Pub. No.: US 2025/0290489 A1
(43) Pub. Date: Sep. 18, 2025

(54) Coupling and drive train for a wind turbine

(71) Applicant: KTR Systems GmbH, Rheine (DE)

(72) Inventors: Reinhard Wibbeling, Hopsten (DE); Reiner Banemann, Rheine (DE); Norbert Partmann, Nordhorn (DE)

(21) Appl. No.: 19/077,513

(22) Filed: Mar. 12, 2025

(30) Foreign Application Priority Data
Mar. 12, 2024 (DE) 102024106980.5

(51) Int. Cl. F03D 15/00; F16D 7/02

(52) U.S. Cl. CPC F03D 15/00; F16D 7/027; F05B 2260/402

(57) ABSTRACT

A coupling for a drive train of a wind turbine between the gearbox and the generator has a drive-side coupling hub, an output-side coupling hub and an intermediate section. The coupling has a torque limiter. In order to create a generic drive train, which is designed such that in the event of an overload, significantly higher energies can be absorbed, the torque limiter has more than two friction elements, in particular disks.

### FIELD OF THE INVENTION

The invention relates to a coupling and a drive train for a wind turbine.

### BACKGROUND OF THE INVENTION

The drive train has the coupling with two connecting flanges rotating against each other, with a torque limiter.

Such a drive train, in particular the main bearing arrangement in a wind turbine, which extends along an axis of rotation, is of known art from DE 10 2021 106 616 A1.

Another drive train for a wind turbine is of known art from EP 2617994 A1.

The problem with such couplings for wind turbines is that torque limiters, usually in the form of a slip unit, are used in the coupling to protect the drive components from overload. High peaks in torque can occur, particularly in the event of power grid interruptions, which can lead to damage and the failure of wind turbine drive components. In order to protect the wind turbines from these peaks in torque, the said torque limiters are used in the drive train of the wind turbines. As a result of the steady increase in performance and higher utilisation of wind turbines, the demands placed on the torque limiters are becoming ever greater, so that the systems used up to the present time can no longer meet the requirements in some circumstances.

### SUMMARY

The invention is therefore based on the object of creating a generic form of coupling and a corresponding drive train, which are designed such that in the event of an overload significantly higher energies can be absorbed. This object is achieved in a coupling and drive train of a wind turbine between the rotor and generator, whereby the drive train has a coupling with two connecting flanges rotating against each other with a torque limiter, in that the torque limiter has more than two friction elements, in particular disks. By this means the energy to be absorbed is distributed over a larger region. Longer slipping times and therefore less heating are achieved.

Here the friction elements are preferably designed as friction flanges that rotate against each other and heat up against each other. A friction lining is preferably arranged between the friction flanges. The friction flanges are preferably each connected to one of the two connecting flanges that rotate against each other. A friction flange is preferably then designed with teeth on its inner face without a friction lining, while another friction flange with teeth on the outer face is designed with friction linings (but this can also be the other way round).

In further configurations of the invention, in particular four, in particular six, in particular eight friction elements, in particular friction flanges, are provided. In other configurations, even more friction elements can also be provided. This is particularly advantageous if particularly high energies must be absorbed.

Another development of the invention is that the contact pressure of the friction elements, in particular the friction flanges, is adjustable. This enables a flexible adaptation to the friction, that is to say. to the slipping torque.

A central development of the invention is that the drive train has an intermediate coupling section and that the torque limiter is arranged in this intermediate coupling section. By the use of such an intermediate coupling section, the torque limiter can be positioned precisely at this point, and the heat can also be dissipated better there. The friction flanges are preferably held alternately, once on the outer face in the intermediate coupling section, and once on the inner face in the intermediate coupling section. A friction lining is preferably arranged between each of the alternately held friction flanges. The friction lining is preferably designed as an independent component. In an alternative configuration, the friction lining is connected to one of the friction flanges in each case.

The friction flanges are preferably fitted with a disc spring or a disc spring assembly for purposes of adjusting the slipping torque. The contact pressure of the friction flanges can conveniently be adjusted with clamping screws. In another configuration of the invention, the two connecting flanges are designed to overlap each other and friction flanges are arranged alternately in each of the two connecting flanges. In this case, both connecting flanges of the friction flanges are adjustable.

In another development of the invention, the coupling has a coupling hub on the drive side or output side, and the torque limiter is integrated in the coupling hub. This enables the heat to be dissipated directly in the coupling hub.

At a higher level, another aspect of the invention comprises the provision of a drive train of a wind turbine with a coupling, such as has been described above.

### BRIEF DESCRIPTION OF THE DRAWINGS

In what follows the invention is explained with reference to an example of embodiment that is shown in the figures. In detail:

FIG. 1: shows the basic configuration of the head of a wind turbine with a coupling with a torque limiter;

FIG. 2: shows a first form of embodiment of a torque limiter for wind turbines, in which a central disc spring is integrated in the intermediate coupling section;

FIG. 3: shows a detailed illustration of the form of embodiment in FIG. 2;

FIG. 4: shows a further illustration of a torque limiter in an unexploded view;

FIG. 5: shows another view of the form of embodiment shown in FIG. 4;

FIG. 6: shows a third form of embodiment of the invention, in which the torque limiter is integrated into the coupling hub.

### DETAILED DESCRIPTION

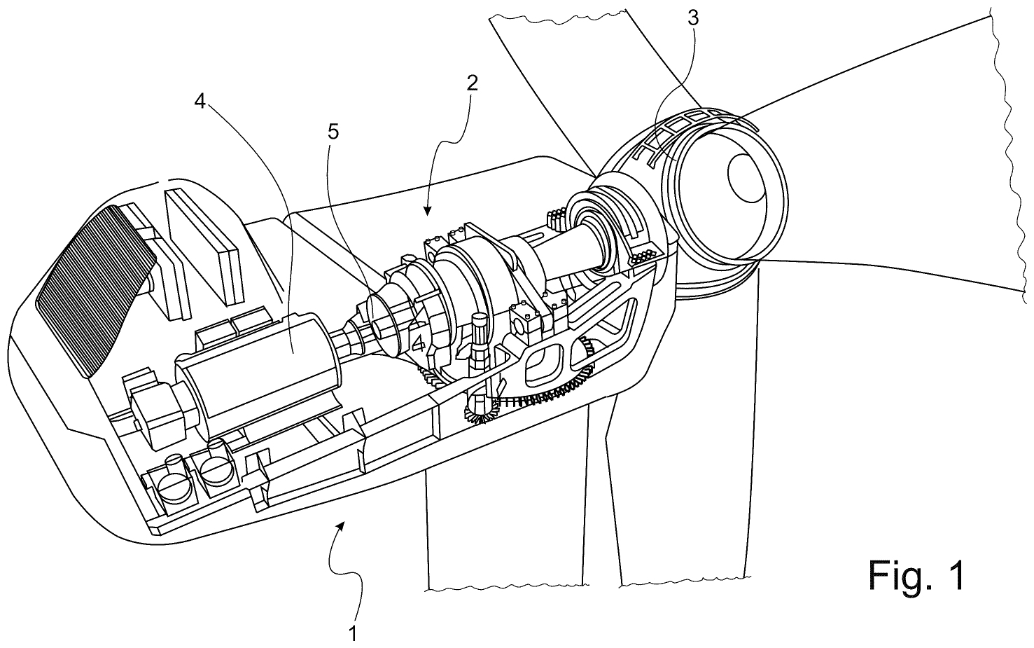

FIG. 1 shows the general construction of the head of a wind turbine 1. The drive train 2 is located between the rotor 3 and the generator 4. The drive train also features a coupling with a torque limiter 5.

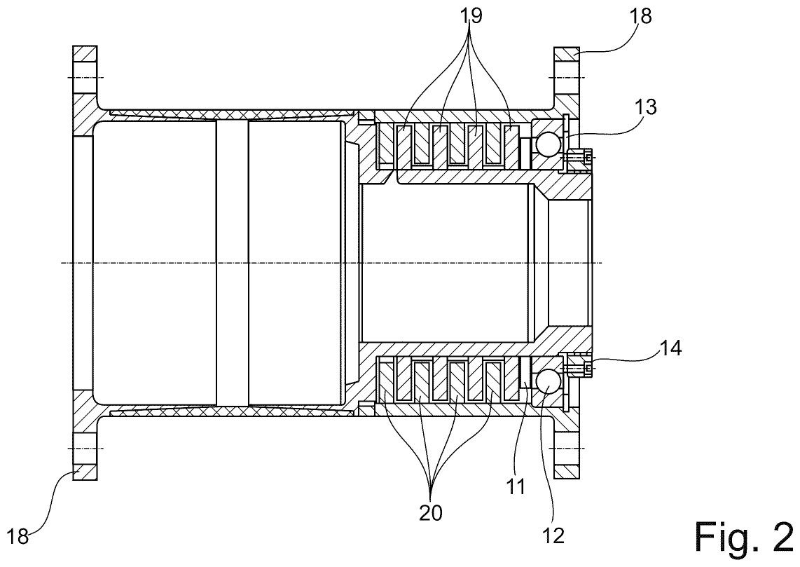

FIG. 2 shows a first form of embodiment of such a torque limiter 5. The latter is integrated into the drive train 2 with connecting flanges 18 and 8, whereby the coupling with the torque limiter 5 can rotate between the opposing connecting flanges 18 and 8 if a certain overload is reached.

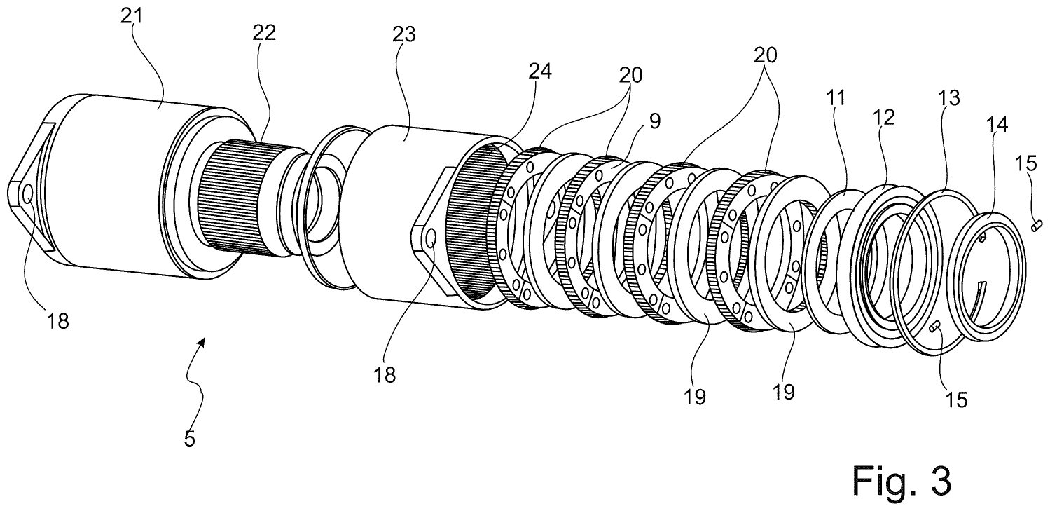

In FIG. 3, the form of embodiment in FIG. 2 is shown once again, this time in an exploded view. In the left-hand region, starting from the connecting flange 18, a tube 21 with an inner flange 22 is featured, whereby this inner flange 22 has outwardly directed toothing, onto which the friction flanges 19 with the internal toothing are pushed. Onto the latter is pushed the outer flange 23 with the internal toothing 24. The said internal toothing 24 corresponds with the friction flanges 20 with external toothing. The friction flanges, which are pushed on alternately, are pushed against the tube 21 in the left-hand region of the figure. In the end region on the right-hand side of the figure, the flanges that are pushed on alternately could theoretically fall out. However, this is prevented by the sequence of disc springs or discspring assemblies 11, a bearing 12, a retaining ring 13 and an adjusting nut 14 with grub screws 15 fitted to the latter.

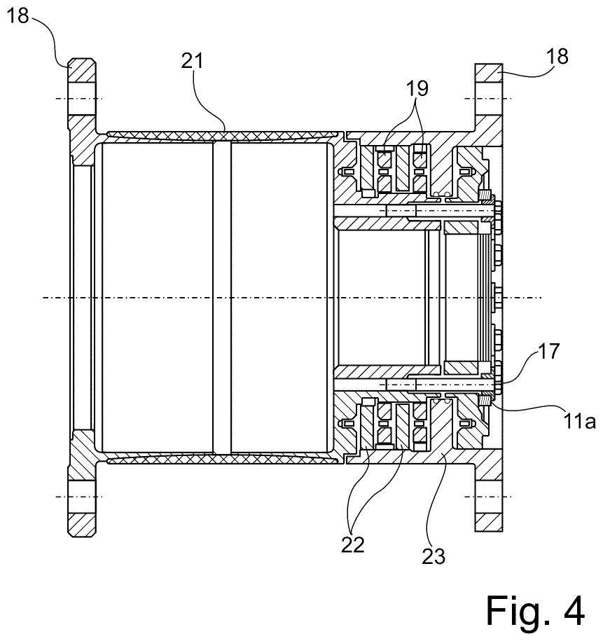

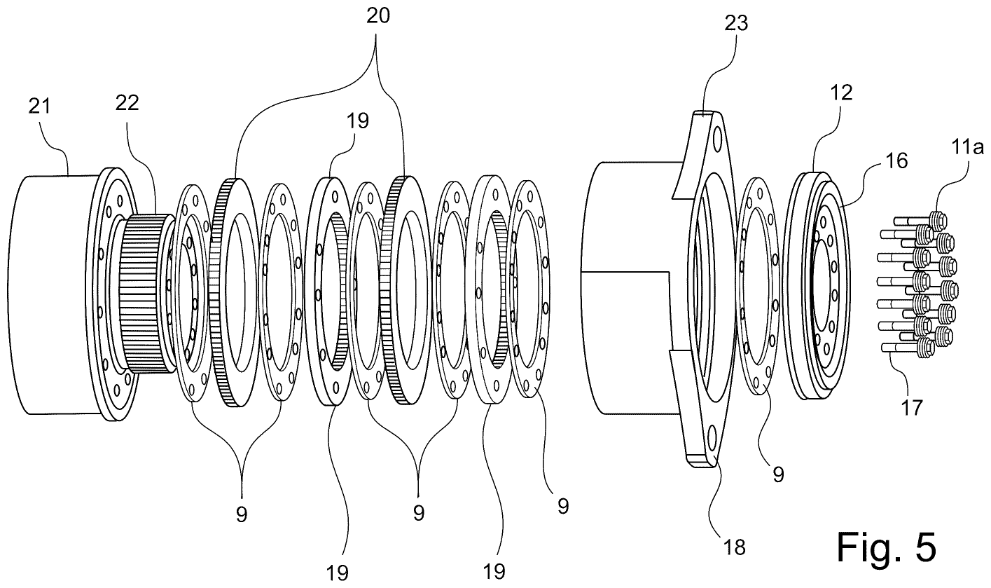

FIGS. 4 and 5 show a second variant of the inventive torque limiter 5 for the drive train of a wind turbine. Identical parts are identified with the same reference numbers. In contrast to the first form of embodiment, which is shown in FIGS. 2 and 3, here the right-hand end region is not secured with a disc spring 11, but with disc spring assemblies 11a and clamping screws 17 fitted to the latter. The disc spring assemblies 11a exert a contact pressure on the overload system 9, 19, and 20, via a pressure flange 16.

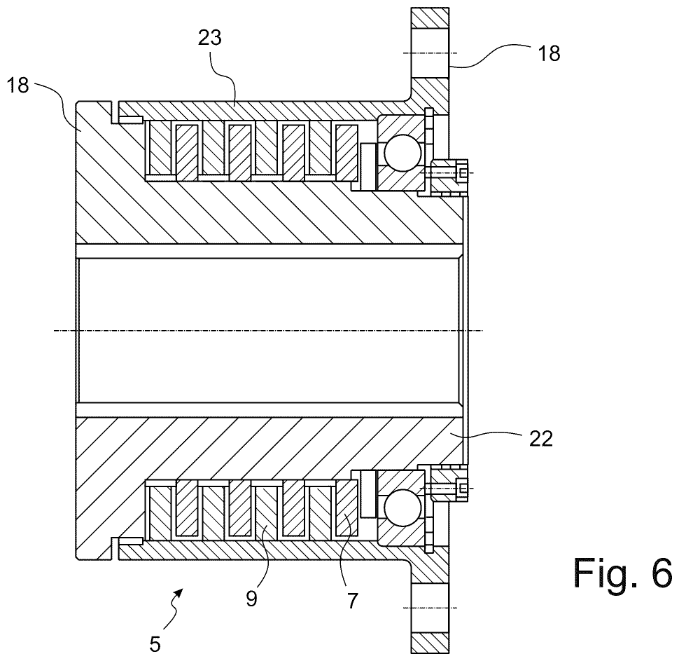

FIG. 6 shows a third form of embodiment of the inventive torque limiter 5 for the drive train of a wind turbine. Here, the two connecting flanges, namely the outer flange 23 and the inner flange 22, are formed in one piece with the friction flanges 19, 20, whereby the friction flanges 19, 20 are arranged alternately on the inner flange 22 and the outer flange 23. If the set torque is exceeded, relative movements occur between the friction flanges 19, 20. The friction flanges 19 are fitted with friction linings 9, which enable particularly good heat dissipation, and particularly good adjustability of the torque at which relative movements occur at the friction flanges 20.

1. A coupling for a drive train of a wind turbine between a transmission and a generator, wherein
wherein the coupling has a coupling hub on a drive input side, and a coupling hub a the drive output side, and an intermediate section,
wherein the coupling has a torque limiter, and
wherein the torque limiter has more than two friction elements, in particular disks.

2. The coupling in accordance with claim 1, wherein the friction elements are designed as friction flanges.

3. The coupling in accordance with claim 2, wherein the friction flanges are designed with an internal set of teeth without friction linings, and
wherein the friction flanges are designed with an external set of teeth with friction linings.

4. The coupling in accordance with claim 2, wherein the friction flanges are designed with an external set of teeth without friction linings, and
wherein the friction flanges are designed with an internal set of teeth with friction linings.

5. The coupling in accordance with claim 1, wherein four friction elements, in particular friction flanges, are provided in the torque limiter.

6. The coupling in accordance with claim 1, wherein the contact pressure of the friction elements, in particular the friction flanges, can be adjusted.

7. The coupling in accordance with claim 1, wherein the coupling has an intermediate coupling section, and
wherein the torque limiter is integrated in the intermediate coupling section.

8. The coupling in accordance with claim 7, wherein the friction flanges are alternately held once on the outer face in the intermediate coupling section, and once on the inner face in the intermediate coupling section, and
wherein a friction lining is arranged between each of the alternately held friction flanges.

9. The coupling in accordance with claim 7, wherein the friction flanges are held in the intermediate coupling section with a tongue-and-groove joint.

10. The coupling in accordance with claim 7, wherein the friction flanges are acted upon by a central disc spring, or by plate discspring assemblies, which are integrated into the intermediate coupling section.

11. The coupling in accordance with claim 1, wherein the torque limiter is arranged in the coupling hub.

12. The coupling in accordance with claim 2, wherein the contact pressure of the friction flanges can be adjusted using clamping nuts, or clamping screws.

13. A drive train for a wind turbine with the coupling in accordance with claim 1.

14. A wind turbine with the drive train, with the coupling in accordance with claim 1.
